(19) United States
(12) Patent Application Publication
(10) Pub. No.: US 2021/0342502 A1
(43) Pub. Date: Nov. 4, 2021

(54) Multiple Objective Optimization Route Selection Method Based on Step Ring Grid Network for Power Transmission Line

(71) Applicant: Northeastern University, Shenyang City, Liaoning Province (CN)

(72) Inventors: Jian FENG, Shenyang (CN); Chunyang YU, Shenyang (CN); Senxiang LU, Shenyang (CN); Chengze REN, Shenyang (CN); Dazhong MA, Shenyang (CN); Yunbo LI, Shenyang (CN); Linping XU, Shenyang (CN)

(21) Appl. No.: 16/621,233

(22) PCT Filed: Sep. 25, 2019
(86) PCT No.: PCT/CN2019/107634

§ 371 Date: Dec. 10, 2019

(30) Foreign Application Priority Data
Sep. 5, 2019 (CN) 201910834937.1

(51) Int. Cl. G06F 30/20; H02J 3/00

(52) U.S. Cl. CPC G06F 30/20; H02J 2203/20; H02J 3/00

(57) ABSTRACT

A multiple objective optimization route selection method based on a step ring grid network for a power transmission line is configured to use multiple data for regional classification and to select virtual topological nodes to construct a virtual topology map. An overall route is planed according to the shortest and optimization route selection method. After selecting the virtual topology route, a semi annular domain of a step ring grid map is constructed through the connections of the topological nodes. After the segmentation of the semi-annular domain to form a plurality of grids, the grids are numbered. The grid attributes of the grids are used for optimizing the route. The multiple objective optimization function is constructed according to a distance function, a cost objective function and an angle cornering objective function, in order to collaboratively optimize the transmission line route.

### FIELD OF INVENTION

The present invention relates to a field of a selection of an optimized route of power transmission line, and more particularly to a power transmission line with a step ring grid network and multiple objective optimization route selection method thereof.

### DESCRIPTION OF RELATED ARTS

As rapid economic growth, the demand of electricity for communities is highly increased. The problem of a power grid planning is also highly concerned by the communities. The power grid planning is considered as a mixed and integrated nonlinear planning with multiple decision variables and multiple constraints. Accordingly, a power transmission line routing, which is a principle of the supply line design and configuration, is well constructed. According to the design and configuration, the power transmission line selection is generally divided into four procedures, i.e. indoor line selection, data collection, preliminary line selection examination, and final line selection examination.

Accordingly, the traditional power transmission line selection is based on a topographic map. However, the information of the topographic map cannot be updated at all times. In addition, China economy has rapidly grown and the urban and rural construction has rapidly accelerated. As a result, there will be an enormous difference between an actual situation and the topographic map. Therefore, the planner must physically visit the site several times for topographic verification and for collection of relevant information from corresponding land and resources bureau. Then, the power transmission line route must be repeatedly corrected and adjusted, so that the planning cycle will be extended. The revised power transmission line route cannot be guaranteed for accuracy and timeliness. This planning method will highly increase the labor cost and material resources. It is dangerous for the planner to physically visit the site for examination and it s complicated and difficult for the planner to analyze the relevant information based on the physical visiting. Thus, it will increase the workload for the planners, the collected information is subjective, and it is lack of systematic integration.

### SUMMARY OF THE PRESENT INVENTION

In order to solve the above technical problems, the objective of the present invention is to provide a multiple objective optimization route selection method based on a step ring grid network for a transmission line, which utilizes GIS data information combined with multiple data, and adopts a multiple objective optimization algorithm to obtain an optimal selection method for routing the transmission line.

The present invention provides a multiple objective optimization route selection method based on a step ring grid network for a transmission line, executed by a computer, comprises the following steps.

Step 1: Select relevant affecting factors to integrate with GIS (geographic information system) data, and construct a characteristic factor indicator set.

Step 2: Divide a semi-annular domain of the constructible tower into multiple species according to regional characteristics, wherein the multiple species are constructed to form a regional characteristic set.

Step 3: Construct a classification algorithm based on the characteristic factor indicator set and the regional characteristic set in order to classify the semi-annular domain of the constructible tower.

Step 4: Select a plurality of topological nodes as a starting point, an end point, a mid-point of residential community, or a must-passing point, wherein a virtual topology route network is generated via the topological nodes to construct a virtual topology map, wherein an actual route is planed based on the virtual topology map.

Step 5: Classify the topological nodes according to the classification algorithm and assign a value for each topological node via distances between topological nodes in order to select an optimized topology overall route in the virtual topology map.

Step 6: Construct a regional step ring grid map between adjacent topological nodes in the optimized topology overall route, construct a constructible tower domain as a semi-annular domain, divide the semi-annular domain between adjacent topological nodes into a plurality of grids, and number the grids.

Step 7: Collect the GIS data, screen the grids in the constructible domain as constructible grids based on elevation factors of the non-constructible domain as non-constructible grids, number the constructible grids and the non-constructible grids, and configure the constructible grids as pre-selected domains.

Step 8: Determine a complexity of each constructible grid in the preselected domain based on Gini coefficient.

Step 9: Configure parameters of the constructible grid in the constructible domain and configure a distance function according to the parameters of latitude and longitude properties, and a height of the constructible tower.

Step 10: Construct a cost objective function according to the step ring grid map.

Step 11: Construct an angle cornering objective function based on an angle between two adjacent constructible towers.

Step 12: Construct a multiple objective optimization function based on the distance function, the cost objective function, and the angle cornering objective function, in order to collaboratively optimize the transmission line route.

According to the multiple objective optimization route selection method based on a step ring grid network for a transmission line of the present invention, the step 2 further comprises a step of:

dividing a constructible annular domain into a walk-able domain, a pass-able domain, an across-able domain and an infeasible domain, and defining the regional characteristic set as D={dₘ, m=1, 2, . . . , M}, wherein dₘ refers to a regional indicator.

According to the multiple objective optimization route selection method based on a step ring grid network for a transmission line of the present invention, the step 3 further comprises the steps of:

Step 3.1: representing the characteristic factor indicator set as F={f₁, f₂, . . . f₁, . . . , F_{N}_{₁}}, wherein i<N₁, i∈Z, N₁ represents number of characteristic factor indicators, f₁ represents a selected characteristic factor indicator, contrasting a construction characteristic set R₁, R₂, wherein R₁, R₂⊆F, R₁∩R₂=Ø, R₁∪R₂=F, wherein R₁ contains k number of sub-elements, and R₂ contains q number of sub-elements, wherein k+q=N₁, wherein R₁={rᵢ⁽¹⁾, i=1, 2, . . . , k} is an auxiliary decision set, to assign a value of cost estimation as rᵢ⁽¹⁾∈(0,1), wherein R₂={rⱼ⁽²⁾, j=1, 2, . . . , q} is a master decision set, wherein a value of decision making is rⱼ⁽²⁾∈{0,1}, wherein 0 refers to non-constructible value and 1 refers to constructible value; and

Step 3.2: providing a common determination of the auxiliary decision set as

$${R}_{u} = ⋁ ⌈ \frac{{kr}_{i}^{( 1 )}}{{\sum }_{i = 1}^{k} {r}_{i}^{1}} - {S}_{cale} ⌉ ,$$

wherein S_{cale} represents an occupation ratio, wherein intersection operational determination for each master decision set is R₁=Λrⱼ⁽²⁾, wherein Rᵤ and Rₗ are logical operational results, wherein R=Rᵤ ΛRₗ, wherein value 1 refers to the constructible value and value 0 refers to the non-constructible value.

According to the multiple objective optimization route selection method based on a step ring grid network for a transmission line of the present invention, the step 5 further comprises a step of:

classifying the topological nodes according to the classification algorithm to eliminate the infeasible domain, setting a vector weight of the topological node from the starting point to the end point as ω_{I}=(ω₁, ω₂, . . . , ω_{N})^{T}, wherein n represents number of connections at each topological node. According to the selection of the topological node in the virtual topology map, a topological node set from the starting point to the end point is represented as O_{T}=(O₁, O₂, . . . , Oₙ)^{T}, wherein the shortest route determined by a topological equation of L_{T}=ω_{T}^{T}·O_{T} is the optimized topology overall route.

According to the multiple objective optimization route selection method based on a step ring grid network for a transmission line of the present invention, the step 6 further comprises the steps of:

Step 6.1: setting one of the topological nodes as the origin of coordinate, wherein a transverse axis is formed by connecting two adjacent topological nodes as a positive direction, so as to form a Cartesian coordinate system;

Step 6.2: converting an overall topology map via coordinate-conversion to form a unified coordinate system for simplifying a computing calculation, wherein the constructible tower is configured to form only in I quadrant and II quadrant of the Cartesian coordinate system;

Step 6.3: determining a distance between the constructible towers based on engineering requirements and on site working conditions, l∈[m, n], wherein m represents the minimum distance between the constructible towers, and n represents the maximum distance of the constructible tower, wherein a coordinate of the tower is set as Sⱼ=(xₒ_{ⱼ}, yₒ_{ⱼ}), wherein Sⱼ represents the j th of the tower, Sⱼ represents a center to form two concentric circles with radius m and radius n respectively. Sⱼ₊₁ is selected to form the following equation:

$$\{ \begin{matrix}{m}^{2} \leq {( {x}_{{O}_{j + 1}} - {x}_{{O}_{j}} )}^{2} + {( {y}_{{O}_{j + 1}} - {y}_{{O}_{j}} )}^{2} \leq {n}^{2} \\ θ = arccos 〈 \overline{{S}_{j} {S}_{j + 1} ,} \overline{{O}_{i} {O}_{i + 1}} 〉 \\ θ ∈ ( 0 , \frac{π}{2} )\end{matrix}$$

wherein a region is formed as the semi-annular domain defined as semi-annular domain Aᵣₑₐ^{j+1}, Sⱼ₊₁∈Aᵣₑₐ^{j+1};

Step 6.4: configuring a grid segmentation of the semi-annular domain, wherein each of the grids is formed in an approximate square shape, wherein after the grid segmentation, the semi-annular domain is constructed to form the map with the step ring grid network; and

Step 6.5: numbering the grids after the segmentation of the semi-annular domain to facilitate optimized calculation.

According to the multiple objective optimization route selection method based on a step ring grid network for a transmission line of the present invention, in the step 8, the Gini coefficient is expressed as:

$$\begin{matrix}Gini ( p ) = {\sum }_{k = 1}^{K} {p}_{k} ( 1 - {p}_{k} ) = 1 - {\sum }_{k = 1}^{K} {p}_{k}^{2} \\ Gini ( {A}_{rea}^{j + 1} , p ) = \frac{\vert {p}_{1} \vert}{\vert {A}_{rea}^{j + 1} \vert} Gini ( {p}_{1} ) + \frac{\vert {p}_{2} \vert}{\vert {A}_{rea}^{j + 1} \vert} Gini ( {p}_{2} )\end{matrix}$$

wherein a probability p₁(S₀,S₁) is set for the constructible tower within the semi-annular domain Aᵣₑₐ^{j+1}, wherein the constructible domain is set as S₁ and the non-constructible domain is set as S₀, wherein pₖ represents an occurrence probability of k th category, wherein a complexity of the particular constructible grid is determined based on the Gini coefficient.

According to the multiple objective optimization route selection method based on a step ring grid network for a transmission line of the present invention, in the step 9, P wherein a grid parameter is configured for each grid, wherein the grid parameter comprises data of cost cᵢₙ, longitude coordinate JᵢₙN₁, latitude coordinate WᵢₙN₁, and elevation coordinate HᵢₙN₁, which are expressed as: D_{N}_{ᵢₙ}^{ata}={cᵢₙ, JᵢₙNᵢ, WᵢₙNᵢ, HᵢₙNᵢ}, wherein n represents the i th grid number of the semi-annular domain, wherein the latitude and longitude coordinates of the grid points are Nᵢₙ=(JᵢₙNᵢ, WᵢₙNᵢ), wherein the latitude and longitude coordinates of the constructible tower Sⱼ is expressed as Sⱼ=(JⱼSⱼ, WⱼSⱼ), which is the distance of the wire between two constructible towers:

lⱼ=(R+HᵢₙNᵢ+h)arccos(cos(WᵢₙNᵢ)cos(WⱼSⱼ)cos(JᵢₙNᵢ−JⱼSⱼ)+sin(WⱼSⱼ)sin(WᵢₙNᵢ))

wherein the assumption is that the Earth is a regular sphere, wherein the radius of Earth is determined by a distance between the sea level and the center of the Earth.

According to the multiple objective optimization route selection method based on a step ring grid network for a transmission line of the present invention, in the step 10, the cost objective function is expressed as:

$$C = μ {\sum }_{i = 1}^{n} {\sum }_{j = 0}^{{m}_{\text{?}}} {c}_{\text{?}} \times {l}_{j} + {\sum }_{k = 1}^{N} [ {c}_{s} {f}_{k} ( F ) + {u}_{s} {G}_{k} ( F ) + {ψ}_{k} + {τ}_{k} ]$$

$$\text{?} \text{indicates text missing or illegible when filed}$$

wherein C represents a total cost, cᵢ represents cost of the wire per unit length, μ represents a power transmission coefficient, wherein a three-phase power transmission process or DC power transmission process adopts different numbers of conductive wires depending on the power transmission type, wherein the power transmission coefficient indicates various power transmissions, wherein n and N represent the number of virtual topology map classifications and the total number of tower respectively, wherein

$${C}_{s} = {\sum }_{i = 1}^{k} {r}_{i}^{( 1 )}$$

represents a cost factor, fₖ(F) represents an estimated construction cost required based on the k th section of the site conditions, uₛ represents a transportation cost factor, Gₖ(F) represents an estimated transportation cost, Ψₖ represents a cost of tower based on the k th section of the site conditions, τₖ represents a labor cost based on the k th section of the site conditions, Setting: when cᵢₙ=cₛfₖ(F)+uₛGₖ(F)+ψₖ+τₖ, an attribute is assigned to the k th section of the constructible grid.

According to the multiple objective optimization route selection method based on a step ring grid network for a transmission line of the present invention, in the step 11,

wherein the starting point is set at one of the virtual topological nodes for the route planning as T={Oᵢ, i≥1∪i∈ [symbol] }, that is, the starting point refers as O₁, and the end point refers as O_{N}, wherein the point of the tower is set as Sⱼ, φ(Sⱼ) is set as the total deflection angle function of the route, the vector between the towers is set as ξ̅ⱼ̅=S̅ⱼ̅S̅ⱼ̅₊̅₁̅, wherein by solving the minimum value of a deflection angle, the function is expressed as:

$$φ ( {S}_{j} ) = min \{ min \{ {\sum }_{i = 1}^{n} {\sum }_{j = 1}^{{m}_{i}} arccos \frac{\vert \overline{{ξ}_{j}} \cdot \overline{{ξ}_{j + 1}} \vert}{\vert \overline{{ξ}_{j}} \vert \vert \overline{{ξ}_{j + 1}} \vert} \} - arccos \frac{\vert \overline{{ξ}_{j}} \cdot \overline{{O}_{1} {O}_{N}} \vert}{\vert \overline{{ξ}_{j}} \vert \vert \overline{{O}_{1} {O}_{N}} \vert} \} ,$$

wherein Sⱼ∈Aᵣ^{eaj}, by setting

$${β}_{j} = arccos \frac{\vert \overline{{ξ}_{j}} \cdot \overline{{ξ}_{j + 1}} \vert}{\vert \overline{{ξ}_{j}} \vert \vert \overline{{ξ}_{j + 1}} \vert} ,$$

the deflection angle is formed by the adjacent semi-annular domain Aᵣₑₐ^{j} in the step ring grid network semi-annular domain Aᵣₑₐ^{j+1} and the selected tower point Sⱼ, selected tower point Sⱼ₊₁, and selected tower point Sⱼ₊₂ in the semi-annular domain Aᵣₑₐ^{j+2}.

According to the multiple objective optimization route selection method based on a step ring grid network for a transmission line of the present invention, in the step 12, the multiple objective optimization model is expressed as:

$$min F ( X ) = {w}_{1} C ( {S}_{j} ) + {w}_{2} {\sum }_{i = 1}^{n} {\sum }_{j = 0}^{{m}_{}} {l}_{j} ( {S}_{j} ) + {w}_{3} φ ( {S}_{j} ) + {ω}_{4} {\sum }_{i = 1}^{n} {\sum }_{j = 0}^{{m}_{}} Gini ( {A}_{rea}^{j + 1} , p )$$

wherein the constructible domain is the semi-annular domain constructed by the stepped annular grid X={Sⱼ|Sⱼ∈Aᵣₑₐ^{j+1}, j=0, 1, 2, . . . , N}, wherein a solution for the optimization problem is to set as X=(S₁, S₂, . . . , S_{N})^{T}.

The objective of the present invention is to provide a multiple objective optimization route selection method based on a step ring grid network for a transmission line, wherein an optimized route is determined by utilizing multiple data and route optimization in a reasonable and efficient manner, and by combining the integrated data with the virtual topology map and the step ring grid map in order to greatly reduce the complexity of the computerization. Thus, the multiple objective optimization model method is used to obtain the comprehensive optimal solution.

### BRIEF DESCRIPTION OF THE DRAWINGS

FIG. 1 is a flow diagram of a power transmission line with a step ring grid network and multiple objective optimization route selection method thereof according to a preferred embodiment of the present invention.

FIG. 2 is a block diagram illustrating different characteristic index for factor indications of the power transmission line according to the above preferred embodiment of the present invention.

FIG. 3 is a schematic view showing a virtual topographic map of the power transmission line according to the above preferred embodiment of the present invention.

FIG. 4a illustrates a map of the step ring grid network of the power transmission line according to the above preferred embodiment of the present invention.

FIG. 4b is a schematic view of a segmentation of the semi-annular domain of the power transmission line according to the above preferred embodiment of the present invention.

FIG. 5 is a schematic view of coordinate transformation of the power transmission line according to the above preferred embodiment of the present invention.

FIG. 6 is a schematic diagram of a map coordinate segmentation slicing method of the step ring grid network according to the above preferred embodiment of the present invention.

FIG. 7 is a schematic diagram showing the schematic numbering of the step ring grid network according to the above preferred embodiment of the present invention.

FIG. 8 is a schematic diagram of angle optimization according to the above preferred embodiment of the present invention.

### DETAILED DESCRIPTION OF THE PREFERRED EMBODIMENT

The present invention is shown and described in detail below with drawings and embodiments. The following embodiments and drawings are exemplary only and not intended to be limiting.

The present invention selects a 220 kV external power supply as an application or an example. According to the calculation and analysis of the transmission capacity of the power system, the power transmission line has a cross sectional area of 400 mm². After comparison and analysis, it is recommended that the engineering wire is JL/G1A-400/35 steel core aluminum stranded wire. According to the requirement for system communication, the ground wire employs two 48-core OPGW optical cables as a lightning ground wires. When incorporating with JL/G1A-400/35 type conductive wire, the wire suspended insulator in a string unit is made of 120 kN composite insulator and 100 kN series of fittings. When incorporating with 2×JL/G1A-400/35 type conductive wire, the wire suspended insulator in a string unit is made of 120 kN composite insulator and 120 kN series of fittings. The line extension distance in the air is about 10 km.

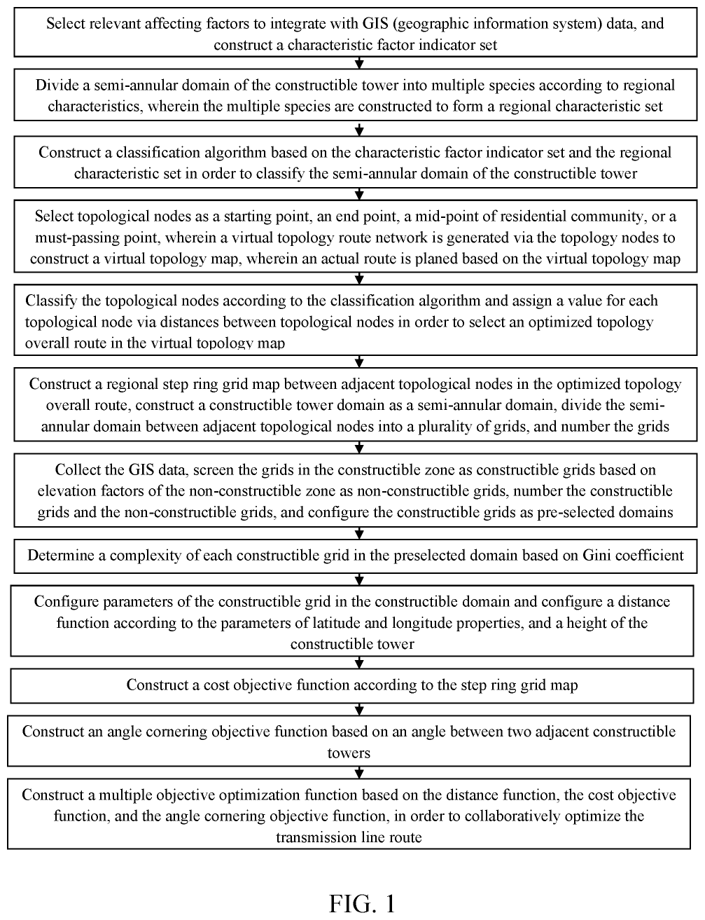

As shown in FIG. 1, in order to solve the above technical problem, the present invention provides a power transmission line with a step ring grid network and multiple objective optimization route selection method thereof, through a computing device, comprises the following steps.

Step 1: Select relevant affecting factors to integrate with GIS (geographic information system) data, and construct a characteristic factor indicator set F={f₁, f₂, . . . fᵢ, . . . , f_{N}_{₁}}, wherein i<N₁, i∈Z; N₁ representing a selected indicator as a reference indicator, and fᵢ representing a selected indicator as a characteristic indicator. For characterizing a selected domain, a set of structural characteristic factor is constructed.

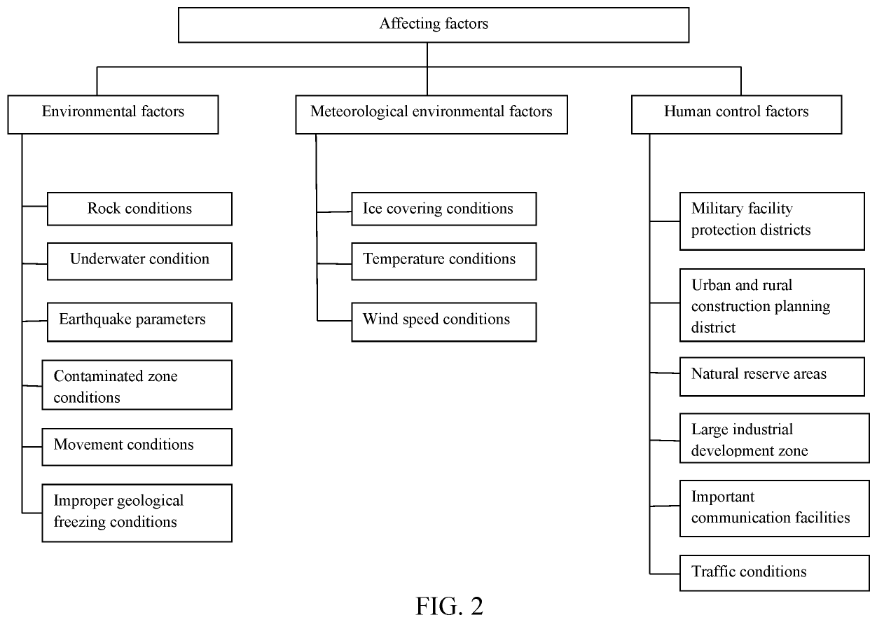

As shown in FIG. 2, the route of the power transmission line is selected and installed based on environmental factors, meteorological environmental factors, and human control factors. Preferably, 15 indicators are selected as characteristic indicators. That is N₁=15. The characteristic indicators can be f₁ geotechnical conditions, f₂ groundwater conditions, f₃ earthquake parameters, f₄ contaminated zone conditions, f₅ movement conditions, f₆ improper geological freezing conditions, f₇ ice covering conditions, f₈ temperature conditions, f₉ wind speed conditions, f₁₀ military facility protection districts, f₁₁ urban and rural construction planning district, f₁₂ natural reserve areas, f₁₃ large industrial development zone, f₁₄ important communication facilities, and f₁₅ traffic conditions. That is, the set of characteristic factor indicators is constructed as follows:

F={geotechnical conditions, groundwater conditions, earthquake parameters, contaminated zone conditions, movement conditions, improper geological freezing conditions; ice covering conditions, temperature conditions, wind speed conditions, urban and rural construction planning district, military facility protection districts, urban and rural construction planning district, natural reserve areas, national forest and land, large industrial development zone, important communication facilities, and traffic conditions}

This set of characteristic factor indicators should meet the construction and requirement for specifications of GB50233-2014110kV-750 kV overhead transmission line.

The technologies for route selection are used including satellite images, aerial images, and all-digital measurement system and infrared measurements. Under complicated geological conditions, geological remote detecting technology is used to include different factors, such as route length, topography, address, icing area, traffic area, construction zone, operation and local planning, to form multiple technology and economy projects for compassion so as to achieve safety, reliability, environmental friendly and economic rationality. The route selection should avoid any military facility, large-scale industry area and important facility, etc., to incorporate with the city planning.

The route selection should avoid the improper geological zones and mining infection zones. It should take necessary measures when these factors are unavoidable. The route selection should avoid heavy snow areas, movement areas and other areas that affect safe operation. The route selection should also avoid primitive forests, nature reserves and famous tourist areas.

The route selection should be considered the interaction of nearby facilities such as radio stations, airports, and weak point power line.

The route selection should be considered close to existing national highways, state highways, county roads and city roads, in order to maximize the full usage of existing traffic conditions to facilitate construction and operation.

The route planning should be unified with in-and-out line, two-way or multi-way line adjacent routes of large power plants and hub station. Same supporting tower should be used in crowded area.

The lengths of tensile segments in the light, medium and heavy icing areas are not greater than 10 km, 5 km, and 3 km respectively. An anti-series-collapsing measure should be taken when the length of the tensile segment is too long. The length of the tensile segment should be appropriately shortened in some areas with poor transporting conditions, such as mountain areas and heavy icing areas where having a large elevation differential or span differential. Independent tensile segments of the power transmission line route should be used for major railways and intersections of highways.

When selecting and positioning the route in the mountain area, it should be paid attention to control the use of the span and the corresponding elevation difference so as to prevent any extreme overhead gap between two towers. It should take necessary measures to improve the height safety if such factor is unavoidable.

For large span of transmission lines, the route plan should be considered with the large leap situation through the comprehensive technical and economic comparison.

The configuration of meteorological conditions should be determined based on mathematical statistics of meteorological data along with the operational configuration of the nearby existing routes. When the climate condition for the route is close to the typical meteorological area, the threshold of the typical meteorological area should be used. The basic wind speed and the thickness of ice coating should meet the following requirements:

750 kV, 500 kV transmission line and its major spanning return period should be 50 years.

110 kV-330 kV transmission line and its major spanning return period should be 30 years.

When determining the basic wind speed, the annual maximum wind speed of the local meteorological station and 10 minute time interval should be taken as the sample, wherein the extreme value I should be used as the probability model. The elevation of the wind speed should meet the following requirements:

110 kV-330 kV transmission line with the statistical wind speed should be taken from 10 m off the ground.

The statistical wind speed of the voltage across the various levels should be taken by the lowest average value in the past high wind season from 10 m off the ground.

For configuring the transmission line route in mountain areas, statistical analysis and contrast observation methods can be used. The basic wind speed in the mountain area can be estimated from the meteorological data of the nearby regional meteorological stations and local meteorological stations, and can be combined with actual operational experience. In case of no reliable information or data, the basic wind speed in the mountain area can be estimated by increasing the statistical value of plain area by 10%.

The basic wind speed of 110 kV-330 kV transmission line should not lower than 23.5 m/s. The basic wind speed of 500 kV-750 kV transmission line should not lower than 27 m/s. If necessary, the conditions according to the rare wind speed should be checked.

For light icing area, the thickness of ice coating is divided into no ice coating, 5 mm ice coating, and 10 mm ice coating. For medium icing area, the thickness of ice coating is divided into 15 mm ice coating and 20 mm ice coating. For heavy icing area, the thickness of ice coating is divided into 20 mm ice coating, 30 mm ice coating, 40 mm ice coating and 50 mm ice coating. If necessary, the conditions according to the rare icing should be checked.

The design of ground wire should be considered by the thickness of ice coating. Except the ice-free area, it should be increased by 5 mm comparing with the wire.

During the route design, it is necessary to ensure the investigation of the design and operation of the existing lines along the line route. Micro-topography, micro-meteorological conditions and the wire movement area should also be considered.

When there is no reliable date, the large span basic wind speed can be determined by converting the statistical value of the wind speed of the nearby land transmission line to the average minimum value of the high wind season from 10 m off the ground, and increasing such value by 10%. The value should be increased additional 10% above the water surface area. The large span basic wind speed should not be lower than the basic wind speed of the connected transmission line along the road.

For large span ice coating, except for the ice-free area, the value input into the circuit design by increasing the thickness of the ice coating by 5 mm.

The value of the annual average temperature for route configuration is determined by:

When the annual average regional temperature is between 3° C. and 17° C., the value of the annual average temperature is 5 times of the annual average temperature region value.

When the annual average regional temperature is less than 3° C. or greater than 17° C., the value of the annual average temperature is determined by subtracting the 3° C. and then multiplying that value by 5 times for the annual average regional temperature being less than 3° C. or by subtracting the 5° C. and then multiplying that value by 5 times for the annual average regional temperature being greater than 17° C.

The wind speed for the installation conditions is set at 10 m/s. The ice condition is set as the ice-free condition, and the temperature is set as follows:

The temperature is set at −15° C. when the lowest regional temperature is −40° C.

The temperature is set at −10° C. when the lowest regional temperature is −20° C.

The temperature is set at −5° C. when the lowest regional temperature is −10° C.

The temperature is set at 0° C. when the lowest regional temperature is −5° C.

The temperature for the lightning surge is set at 15° C. When the basic wind speed is converted based on the average height of the conductive wire is greater than 35 m/s, the basic wind speed for the lightning surge is set at 15 m/s. Otherwise, the basic wind speed for the lightning surge is set at 10 m/s. A distance between the conductive wire and the ground wire is examined under a wind-free and ice-free condition.

The temperature of the operating over-voltage can be used by the annual average temperature. The wind speed is determined by taking 50% of the wind speed based on the average height of the conductive wire, wherein the wind speed should not be lower than 15 m/s under the ice-free condition.

Under the working condition, the wind speed can be set as 10 m/s, the temperature can be set as 15° C., and the thickness of the ice coating can be set as zero (ice-free condition).

For the overhead transmission line passing through urban areas or forest, etc, if the average height of two obstacles is greater than ⅔ of the height of the tower, the maximum wind speed must be reduced 20% of the maximum local wind speed.

Step 2: Divide a semi-annular domain of the constructible tower into multiple species according to regional characteristics, wherein the multiple species are constructed to form a regional characteristic set.

The regional characteristic set is defined as D={dₘ, m=1, 2, . . . , M}, wherein dₘ refers to a regional indicator, and M refers to sum of the multiple species.

In the embodiment, the constructible annular domain is divided into four different domains, i.e. a walk-able domain, a pass-able domain, an across-able domain and infeasible domain. Therefore, M=4, wherein d₁=walk-able domain, d₂=pass-able domain, d₃=across-able domain and d₄=infeasible domain.

Step 3: Construct a classification algorithm based on the characteristic factor indicator set and the regional characteristic set, wherein the semi-annular domain of the constructible tower is classified as:

Step 3.1: The characteristic factor indicator set is represented as F={f₁, f₂, . . . fᵢ, . . . , f_{N}_{₁}}, wherein i<N₁, i∈Z, N₁ represents the number of characteristic factor indicators, fᵢ represents a selected characteristic factor indicator. The construction characteristic set R₁, R₂ is constructed, wherein R₁, R₂⊆F, R₁∩R₂≠Ø, R₁∪R₂=F. R₁ contains k number of sub-elements, and R₂ contains q number of sub-elements, wherein k+q=N₁. In other words, R₁={rᵢ⁽¹⁾, i=1, 2, . . . , k} is an auxiliary decision set, to assign a value of the cost estimation as rᵢ⁽¹⁾∈(0,1). R₂={rⱼ⁽²⁾, j=1, 2, . . . , q} is the master decision set, wherein a value of the decision making is rⱼ⁽²⁾∈{0,1}, wherein 0 refers to non-constructible value and 1 refers to constructible value.

Step 3.2: The common determination of the auxiliary decision set is

$${R}_{u} = ⋁ ⌈ \frac{{kr}_{i}^{( 1 )}}{{\sum }_{i = 1}^{k} {r}_{i}^{1}} - {S}_{cale} ⌉ ,$$

wherein S_{cale} represents an occupation ratio, wherein intersection operational determination for each master decision set is Rₗ=∧rⱼ⁽²⁾. The Rᵤ and R_{I} are logical operational results. That is, R=Rᵤ∧Rₗ, wherein the value 1 refers to the constructible value and the value 0 refers to the non-constructible value.

Under the specific implementation:

R₁={rock condition, underwater condition, earthquake parameter, contaminated zone condition, movement condition, improper geological freezing condition, ice covering condition, temperature condition, and wind speed condition}

R₂={urban and rural construction planning district, natural reserve areas, national forest and land, large industrial development zone, important communication facilities, and traffic condition}

A feasible regional function is constructed and combined with GIS data and the remote detecting data with the set of the characteristic factor indicators F={f₁, f₂, . . . fᵢ, . . . , f_{N}}. The probability of constructing the tower with the semi-annular domain is set as p₁(S₀,S₁). The probability of non-constructible tower is set as p₂(S₀,S₁). The constructible domain is set as S₁ and the non-constructible domain is set as S₀. Under the condition of feature F, the mapping by step grid is determined based on the medium occupancy ratio.

Under the condition of the feature, the step-and-loop map is determined according to the middle occupancy ratio. The construction occupation ratio is set as

$${S}_{cale} = log \frac{{p}_{1} ( {S}_{0} , {S}_{1} )}{{p}_{2} ( {S}_{0} , {S}_{1} )} ,$$

wherein when S_{cale}>−0.477, the grid at the map can be used for tower construction.

The parameter being set in the step (3) meets the requirements and acceptance specifications of GB50233-2014110 kV-750 kV overhead transmission line. According to the evaluation by the experts and the examinations by the different collaborative departments, the weight attributes and configurations of R₁ and R₂ are constructed.

Step 4: Selection of topological nodes. The topological node can be defined as a starting point, an end point, a mid-point of residential community, or a must-passing point (a destination route point such as substation, grid connection point). A virtual topology route network is generated via the topological nodes to construct a virtual topology map, wherein the actual route can be significantly planed based on the virtual topology map.

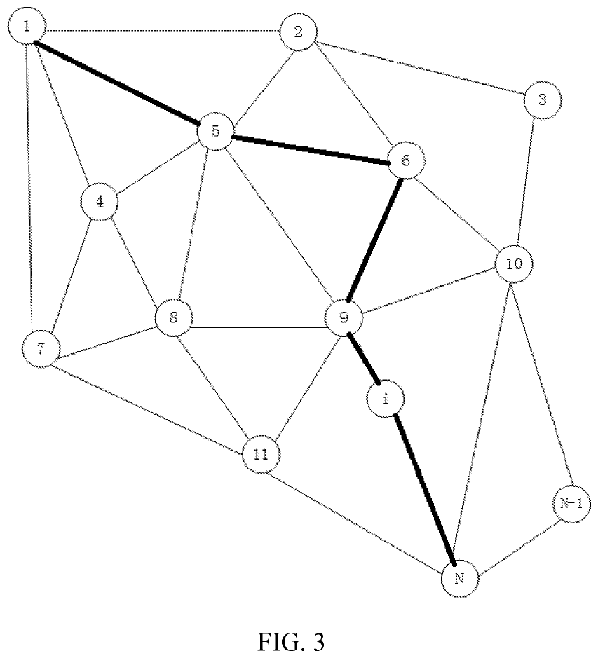

FIG. 3 shows the virtual topology map, wherein reference character 1 refers to the starting point, and reference character 13 refers to the end point. The overall route plan is based on the virtual topology map. The set of topological nodes is set as T={Oᵢ, i≥1∪i∈ [symbol] }. By combining and linking all the topological nodes from the starting point to the end point, the virtual topology map is formed.

Step 5: Classify the topological nodes according to the classification algorithm and assign a value for each topological node via distances between topological nodes in order to select an optimized topology overall route in the virtual topology map. The vector weight of the topological node from the starting point to the end point is set as ωᵣ=(ω₁, ω₂, . . . , ωₙ)^{T}, wherein n represents number of connections at each topological node, representing a topological node set from the starting point to the end point as Oᵣ=(O₁, O₂, . . . , Oₙ)^{T}. The shortest route determined by the topological equation of L_{T}=ω_{T}^{T}·Oᵣ is the optimized topology overall route.

Except the top side of the transmission line across support that the transmission line is across above, the tower must be set up before the power must be shut down for the transmission line to ensure the safety regarding the operator, working tools, and the supporting frame so as to meet the requirement of DL 5009.2-2013 “Safety Regulations for Electric Power Construction Part 2: Overhead Transmission Lines”. The optimized topology overall route is selected in response to the topological map. As shown in FIG. 3, the optimized topology overall route is shown in a bold line by selecting the topological nodes T={O₁, O₅, O₅, O₉, . . . , Oᵢ, . . . , O_{N}}.

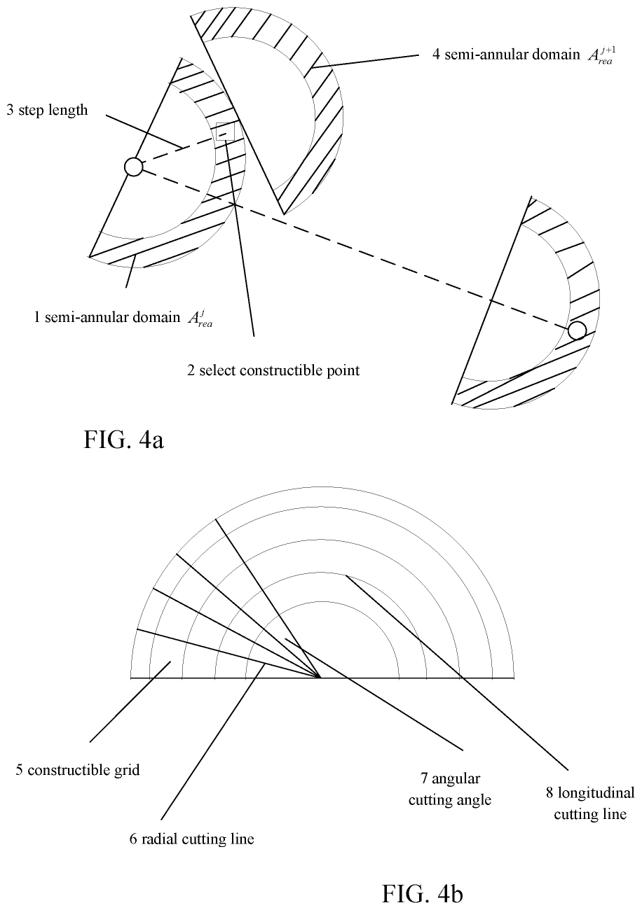

Step 6: Construct a regional step ring grid map between adjacent topological nodes in the optimized topology overall route, construct a constructible tower domain as a semi-annular domain, divide the semi-annular domain between adjacent topological nodes into a plurality of grids, and number the grids. As shown in FIG. 4a, the map with the step ring grid network is shown, wherein the step 6 comprises the steps of:

Step 6.1: The topological node is set as the origin of coordinate, wherein a transverse axis is formed by connecting two adjacent topological nodes as a positive direction, so as to form a Cartesian coordinate system.

According to the embodiment, the coordinate system is established, wherein the topological node is set as the origin of coordinate Oᵢ, the transverse axis is set as y-axis to extend along the position direction \vec{OᵢOᵢ₊₁}, so as to form the Cartesian coordinate system xOᵢy.

Step 6.2: The overall topology map is coordinate-conversion to form a unified coordinate system. The use of coordinate-conversion will simplify the computing calculation, such that the constructible tower will only be formed in the I quadrant and the II quadrant of the Cartesian coordinate system.

In the embodiment, the coordinate is set as

$$\{ \begin{matrix}{x}_{{O}_{i + 1}} = {x}_{{O}_{i}} cos {α}_{i + 1} + {y}_{{O}_{i}} sin α + {a}_{i} \\ {y}_{{O}_{i + 1}} = {y}_{{O}_{i}} cos {α}_{i + 1} - {x}_{{O}_{i}} sin α + {b}_{i}\end{matrix} ,$$

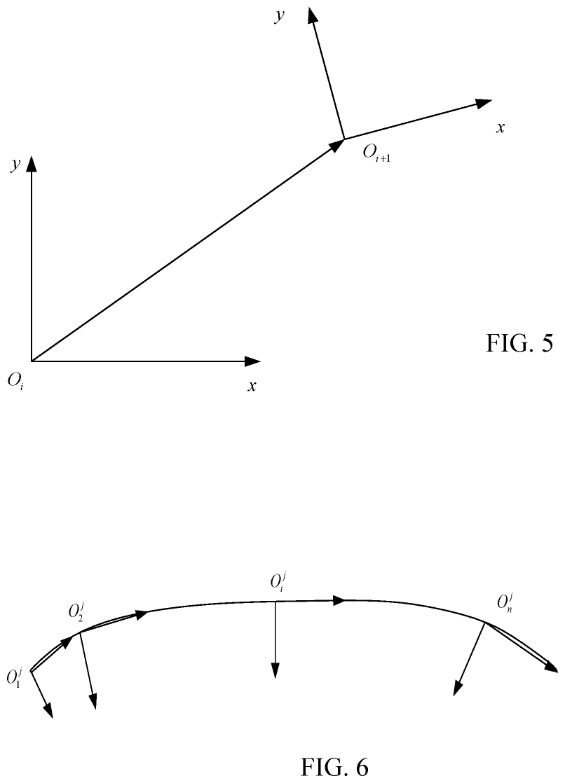

such that the coordinates are shifted in a rotational manner. As shown in FIG. 5, the coordinate (aᵢ,bᵢ) is configured as the origin of the next coordinate system relative to the coordinate of the previous coordinate system. The αᵢ₊₁ is an angular shifting angle of the i+1 th coordinate system relative to the coordinate of the i th coordinate system. The overall topology map is transformed to form the unified coordinate system, wherein the use of coordinate-conversion will simplify the computing calculation, such that the base of the tower will only be formed in the I quadrant and the II quadrant.

Step 6.3: A distance between the constructible towers is determined based on engineering requirements and on site working conditions, l∈[m, n], wherein m represents the minimum distance between the towers, and n represents the maximum distance of the constructible tower. The coordinate of the tower is set as Sⱼ=(xₒ_{ⱼ}, yₒ_{ⱼ}), wherein Sⱼ represents the j th of the tower, Sⱼ is the center to form two concentric circles with radius m and radius n respectively. Sⱼ₊₁ is selected to form the following equation:

$$\{ \begin{matrix}{m}^{2} \leq {( {x}_{{O}_{j + 1}} - {x}_{{O}_{j}} )}^{2} + {( {y}_{{O}_{j + 1}} - {y}_{{O}_{j}} )}^{2} \leq {n}^{2} \\ θ = arccos 〈 \overline{{S}_{j} {S}_{j + 1} ,} \overline{{O}_{i} {O}_{i + 1}} 〉 \\ θ ∈ ( 0 , \frac{π}{2} )\end{matrix}$$

The region is formed as the semi-annular domain defined as semi-annular domain Aᵣₑₐ^{j+1}, Sⱼ₊₁∈Aᵣₑₐ^{j+1}.

FIG. 4a shows the semi-annular domain, wherein reference character 1 refers to the semi-annular domain, reference character 2 refers to the tower construction point, reference character 3 refers to the step length, and reference character 4 refers to next step semi-annular domain.

Step 6.4: Configure a grid segmentation of the semi-annular domain, wherein each of the grids is formed in an approximate square shape. After the grid segmentation, the semi-annular domain is constructed to form the map with the step ring grid network.

According to the embodiment, within the semi-annular domain Aᵣₑₐ^{j+1}, the step ring grid network map is formed by the grids a. FIG. 4b shows that there are 5 grids, wherein semi-annular domain is divided into a portions along the radial direction, wherein

$$σ = [ \frac{n - m}{a} ] ,$$

and a semi-circular arc having a radius m+ai is cut, i=1, 2, . . . , σ, as shown in FIG. 4b with 8 semi-circular cutting line. In response to the center point of the concentric circles of the semi-annular domain, an angular cutting angle ψ is selected,

$$ψ = \frac{180 a}{π ( n - [ \frac{σ}{2} ] \cdot a )} ,$$

to form the grid with approximately square shape. FIG. 4b shows that there are 7 angular cutting angles and 6 radial cutting lines to divide the semi-annular domain into Δ portions, wherein

$$Δ = [ \frac{π}{ψ} ] .$$

The array of grid Δ×σ is formed. For the {Aᵣₑₐ^{j+1}, j=1, 2, . . . , N}, N refers to total number of the semi-annular domain being constructed, such that {Aᵣₑₐ^{j+1}, j=1, 2, . . . , N} is configured to form the step ring grid network map.

Step 6.5: Number the grids in step 6.4 after the segmentation of the semi-annular domain to facilitate optimized calculation.

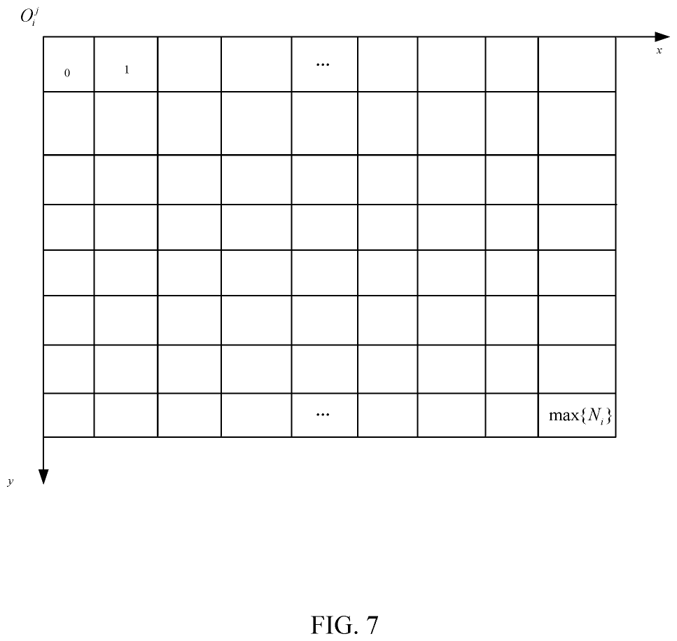

As shown in FIG. 4a for the grid, a center point of the grid serves as a center coordinate point in order to establish the corresponding coordinate system. Since the system is adopted with the step annular map, an outer peripheral of the semi-annular domain Aᵣₑₐ^{j+1} forms a ring shape. The coordinate system is established by using the segmentation method. The curved edge is set as the coordinate system xOᵢ^{j}y to represent the i th of sub-coordinate within the semi-annular domain Aᵣₑₐ^{j+1} via the segmentation method as shown in FIG. 6. The grid in the map is numbered as shown in FIG. 7, wherein the coordinate represents as:

$${N}_{j + 1} = max \{ {N}_{j} \} + int ( \frac{x}{a} ) + \frac{{x}_{len}}{a} \times int ( \frac{y}{a} ) ,$$

wherein xₗₑₙ represents a value range of the grid coordinate, “int” represents a rounding operation, and Nⱼ₊₁ represents the numbering of the coordinate within the semi-annular domain Aᵣₑₐ^{j+1}.

Step 7: Collect the GIS data, screen the grids in the constructible domain as constructible grids based on elevation factors of the non-constructible domain as non-constructible grids, number the constructible grids and the non-constructible grids, and configure the constructible grids as pre-selected domains.

The height of the tower is set as h, wherein each grid in an elevated grid set K={Iₙ, n=1, 2, . . . , N₁} is formed regarding Sⱼ, the elevation Eᵢ, and the semi-annular domain Aᵣₑₐ^{j+1}, wherein at the elevation of the nth grid, N₁ is the number of grids divided from semi-annular domain Aᵣₑₐ^{j+1}. The elevation set E={Eₙᵢ, i=1, 2, . . . , N} is formed regarding the line interval lₓ, wherein Eₙᵢ is an elevation value of the nth grid with respect to elevation sampling points i along the line connection Sⱼ. [symbol] Eₙᵢ∈E, wherein when Eₙᵢ−σ>min{Iₙ+h, Eᵢ+h}, σ representing a safety threshold of the overhead wire, such grid cannot be used for the tower construction.

Step 8: Determine the complexity of each constructible grid in the preselected domain based on Gini coefficient. In the embodiment, the Gini coefficient is expressed as:

$$Gini ( p ) = {\sum }_{k = 1}^{K} {p}_{k} ( 1 - {p}_{k} ) = 1 - {\sum }_{k = 1}^{K} {p}_{k}^{2}$$

$$Gini ( {A}_{rea}^{j + 1} , p ) = \frac{\vert {p}_{1} \vert}{\vert {A}_{rea}^{j + 1} \vert} Gini ( {p}_{1} ) + \frac{\vert {p}_{2} \vert}{\vert {A}_{rea}^{j + 1} \vert} Gini ( {p}_{2} )$$

Accordingly, the probability p₁(S₀,S₁) is set for the constructible tower within the semi-annular domain Aᵣₑₐ^{j+1}. The constructible domain is set as S₁ and the non-constructible domain is set as S₀. pₖ represents the occurrence probability of k th category. The complexity of the particular constructible grid can be determined based on the Gini coefficient.

Step 9: Configure parameters of the constructible grid in the constructible domain and configure a distance function according to the parameters of latitude and longitude properties, and the height of the constructible tower.

Grid parameter is configured for each grid, wherein the grid parameter comprises data of cost cᵢₙ, longitude coordinate JᵢₙNᵢ, latitude coordinates WᵢₙNᵢ, and elevation coordinate HᵢₙNᵢ, which are expressed as: D_{N}_{ᵢₙ}^{ata}={cᵢₙ, JᵢₙNᵢ, WᵢₙNᵢ, HᵢₙNᵢ}. n represents the i th grid number of the semi-annular domain. That is, the latitude and longitude coordinates of the grid points are Nᵢₙ=(JᵢₙNᵢ,WᵢₙNᵢ). The latitude and longitude coordinates of the constructible tower Sⱼ is expressed as Sⱼ=(JⱼSⱼ,WⱼSⱼ), which is the distance of the wire between two constructible towers:

Iⱼ=(R+HᵢₙNᵢ+h)arccos(cos(WᵢₙNᵢ)cos(WⱼSⱼ)cos(JᵢₙNᵢ−JⱼSⱼ)+sin(WⱼSⱼ)sin(WᵢₙNᵢ))

The above assumption is that the Earth is a regular sphere, wherein the radius of Earth is determined by a distance between the sea level and the center of the Earth.

Step 10: Construct a cost objective function according to the step ring grid map.

According to the above step ring grid map and determination, the cost objective function is expressed as

$$C = μ {\sum }_{i = 1}^{n} {\sum }_{j = 0}^{{m}_{i}} {c}_{l} + {l}_{j} + {\sum }_{k = 1}^{N} [ {c}_{s} {f}_{k} ( F ) + {u}_{s} {G}_{k} ( F ) + {ψ}_{k} + {τ}_{k} ] ,$$

wherein C represents the total cost, cᵢ represents the cost of the wire per unit length, μ represents the power transmission coefficient. The three-phase power transmission process or DC power transmission process will adopt different numbers of conductive wires depending on the power transmission type. The power transmission coefficient indicates various power transmissions. n and N represent the number of virtual topology map classifications and the total number of tower respectively.

$${c}_{s} = {\sum }_{j = 1}^{k} {r}_{i}^{( 1 )}$$

represents the cost factor. fₖ(F) represents the estimated construction cost required based on the k th section of the site conditions. uₓ represents the transportation cost factor. Gₖ(F) represents the estimated transportation cost. ψₖ represents the cost of tower based on the k th section of the site conditions. τₖ represents the labor cost based on the k th section of the site conditions. Setting: when cᵢₙ=cₛfₖ(F)+uₛGₖ(F)+ψₖ+τₖ, an attribute can be assigned to the k th section of the constructible grid.

Step 11: Construct an angle cornering objective function based on an angle between two adjacent constructible towers.

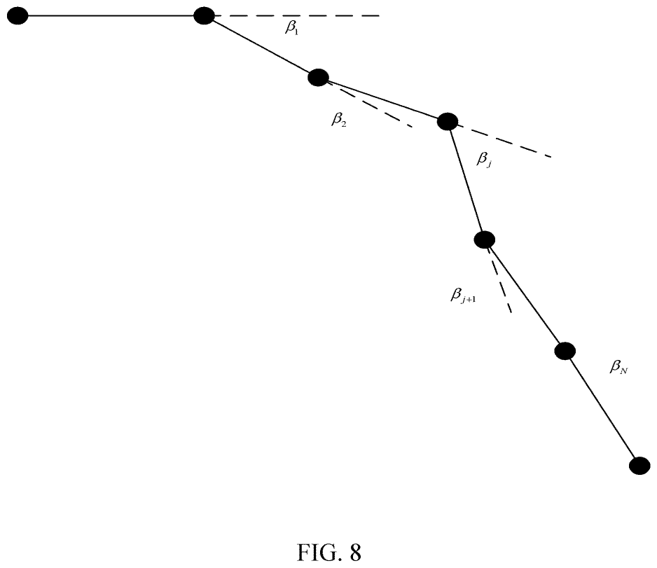

The transmission line design system requires minimizing the line cornering number of towers to ensure the transmission line being extended in a straight line manner. The starting point is set at one of the virtual topological nodes for the route planning as T={Oᵢ, i≥1∪i∈ [symbol] }. That is, the starting point refers as O₁, and the end point refers as O_{N}. The point of the tower is set as Sⱼ, φ(Sⱼ) is set as the total deflection angle function of the route, the vector between the towers is set as ξ̅ⱼ̅=S̅ⱼ̅S̅ⱼ̅₊̅₁̅. By solving the minimum value of the deflection angle, as shown in FIG. 8, the function is expressed as:

$$φ ( {S}_{j} ) = min \{ min \{ {\sum }_{i = 1}^{n} {\sum }_{j = 1}^{{m}_{i}} arccos \frac{\vert \overline{{ξ}_{j}} \cdot \overline{{ξ}_{j + 1}} \vert}{\vert \overline{{ξ}_{j}} \vert \vert \overline{{ξ}_{j + 1}} \vert} \} - arccos \frac{\vert \overline{{ξ}_{j}} \cdot \overline{{O}_{1} {O}_{N}} \vert}{\vert \overline{{ξ}_{j}} \vert \vert \overline{{O}_{1} {O}_{N}} \vert} \} ,$$

Sⱼ∈Aᵣₑₐ^{j}. By setting

$${β}_{j} = arccos \frac{\vert \overline{{ξ}_{j}} \cdot \overline{{ξ}_{j + 1}} \vert}{\vert \overline{{ξ}_{j}} \vert \vert \overline{{ξ}_{j + 1}} \vert} ,$$

the deflection angle is formed by the adjacent semi-annular domain Aᵣₑₐ^{j} in the step ring grid network semi-annular domain Aᵣₑₐ^{j+1} and the selected tower point Sⱼ, selected tower point Sⱼ₊₁, and selected tower point Sⱼ₊₂ in the semi-annular domain Aᵣₑₐ^{j+2}.

Step 12: Construct a multiple objective optimization function based on the distance function, the cost objective function, and the angle cornering objective function, in order to collaboratively optimize the transmission line route. The multiple objective optimization model is expressed as:

$$min F ( X ) = {w}_{1} C ( {S}_{j} ) + {w}_{2} {\sum }_{i = 1}^{n} {\sum }_{j = 0}^{{m}_{i}} {l}_{f} ( {S}_{j} ) + {w}_{3} φ ( {S}_{j} ) + {ω}_{4} {\sum }_{i = 1}^{n} {\sum }_{j = 0}^{{m}_{i}} Gini ( {A}_{rea}^{j + 1} , p )$$

The constructible domain is the semi-annular domain constructed by the step annular grid X={Sⱼ|Sⱼ∈Aᵣₑₐ^{j+1}, j=0, 1, 2, . . . , N}. The solution for the optimization problem is to set as X=(S₁, S₂, . . . , S_{N})^{T}. The main core is to coordinate the relationship between the various objective functions and to find out the optimal solution set for the function value of the various objective functions, i.e. Pareto solution set so as to obtain the optimal solution set {S₁, S₂, . . . , S_{N}} for the system.

According to the embodiment, the algorithm is illustrated as Elitist Non-Dominated Sorting Genetic Algorithm (NSGA-11), wherein NSGA-II is configured to coordinate the relationship between the various objective functions and find the optimal solution set by configuring each objective function to reach a larger (or smaller) function value as much as possible.

The above embodiment as shown in the drawings and described above is exemplary only and not intended to be limiting. The above embodiment has been shown and described for the purposes of illustrating the functional and structural principles of the present invention and is subject to change without departure from such principles. Therefore, this invention includes all modifications encompassed within the spirit and scope of the following claims.

What is claimed is:

1. A multiple objective optimization route selection method based on a step ring grid network for a transmission line, characterized in that, comprising the following steps:
step 1: selecting relevant affecting factors to integrate with GIS (geographic information system) data, and construct a characteristic factor indicator set;
step 2: dividing a semi-annular domain of a constructible tower into multiple species according to regional characteristics, wherein the multiple species are constructed to form a regional characteristic set;
step 3: constructing a classification algorithm based on the characteristic factor indicator set and the regional characteristic set in order to classify the semi-annular domain of the constructible tower is classified;
step 4: selecting a plurality of topological nodes as a starting point, an end point, a mid-point of residential community, or a must-passing point, wherein a virtual topology route network is generated via the topological nodes to construct a virtual topology map, wherein an actual route is planed based on the virtual topology map;
step 5: classifying the topological nodes according to the classification algorithm and assigning a value for each topological node via distances between topological nodes in order to select an optimized topology overall route in the virtual topology map;
step 6: constructing a regional step ring grid map between adjacent topological nodes in the optimized topology overall route, constructing a constructible tower domain as a semi-annular domain, dividing the semi-annular domain between adjacent topological nodes into a plurality of grids, and numbering the grids;
step 7: collecting the GIS data, screen the grids in the constructible domain as constructible grids based on elevation factors of the non-constructible domain as non-constructible grids, numbering the constructible grids and the non-constructible grids, and configuring the constructible grids as pre-selected domains;
step 8: determining a complexity of each constructible grid in the preselected domain based on Gini coefficient;
step 9: configuring parameters of the constructible grid in the constructible domain and configuring a distance function according to the parameters of latitude and longitude properties, and a height of the constructible tower;
step 10: constructing a cost objective function according to the step ring grid map;
step 11: constructing an angle cornering objective function based on an angle between two adjacent constructible towers; and
step 12: constructing a multiple objective optimization function based on the distance function, the cost objective function, and the angle cornering objective function, in order to collaboratively optimize the route of the transmission line.

2. The multiple objective optimization route selection method based on a step ring grid network for a transmission line according to claim 1, characterized in that, wherein the step 2 further comprises a step of:
dividing the constructible annular domain into a walk-able domain, a pass-able domain, an across-able domain and an infeasible domain, and defining the regional characteristic set as D={dₘ, m=1, 2, . . . , M}, wherein dₘ refers to a regional indicator.

3. The multiple objective optimization route selection method based on a step ring grid network for a transmission line according to claim 1, characterized in that, wherein the step 3 further comprises the steps of:
step 3.1: representing the characteristic factor indicator set as F={f₁, f₂, . . . fᵢ, . . . , f_{N}_{ᵢ}}, wherein i<N₁, i∈Z, N₁ represents number of characteristic factor indicators, fᵢ represents a selected characteristic factor indicator, contrasting a construction characteristic set R₁, R₂, wherein R₁, R₂⊆F, R₁∩R₂=Ø, R₁∪R₂=F, wherein R₁ contains k number of sub-elements, and R₂ contains q number of sub-elements, wherein k+q=N₁, wherein R₁={rᵢ⁽¹⁾, i=1, 2, . . . , k} is an auxiliary decision set, to assign a value of cost estimation as rᵢ⁽¹⁾∈(0,1), wherein R₂={rⱼ⁽²⁾, j=1, 2, . . . , q} is a master decision set, wherein a value of decision making is rⱼ⁽²⁾∈{0,1}, wherein 0 refers to non-constructible value and 1 refers to constructible value; and
to step 3.2: providing a common determination of the auxiliary decision set as
$${R}_{n} = ⩔ ⌈ \frac{{kr}_{i}^{( 1 )}}{{\sum }_{i = 1}^{k} {r}_{i}^{1}} - {S}_{cale} ⌉ ,$$
wherein S_{cale} represents an occupation ratio, wherein intersection operational determination for each master decision set is Rₗ=∧rⱼ⁽²⁾, wherein Rᵤ and Rₗ are logical operational results, wherein R=Rᵤ∧Rₗ, wherein value 1 refers to the constructible value and value 0 refers to the non-constructible value.

4. The multiple objective optimization route selection method based on a step ring grid network for a transmission line according to claim 1, characterized in that, wherein the step 5 further comprises a step of:
classifying the topological nodes according to the classification algorithm to eliminate the infeasible domain, setting a vector weight of the topological node from the starting point to the end point as ω_{T}=(ω₁, ω₂, . . . , ωₙ)^{T}, wherein n represents number of connections at each topological node, wherein according to the selection of the topological node in the virtual topology map, a topological node set from the starting point to the end point is represented as O_{T}=(O₁, O₂, . . . , Oₙ)^{T}, wherein the shortest route determined by a topological equation of L_{T}=ω_{T}^{r}·Oᵣ is the optimized topology overall route.

5. The multiple objective optimization route selection method based on a step ring grid network for a transmission line according to claim 1, characterized in that, wherein the step 6 further comprises the steps of:
step 6.1: setting one of the topological nodes as the origin of coordinate, wherein a transverse axis is formed by connecting two adjacent topological nodes as a positive direction, so as to form a Cartesian coordinate system;
step 6.2: converting an overall topology map via coordinate-conversion to form a unified coordinate system for simplifying a computing calculation, wherein the constructible tower is configured to form only in I quadrant and II quadrant of the Cartesian coordinate system;
step 6.3: determining a distance between the constructible towers based on engineering requirements and on site working conditions, l∈[m, n], wherein m represents the minimum distance between the constructible towers, and n represents the maximum distance of the constructible tower, wherein a coordinate of the tower is set as Sⱼ=(xₒ_{ⱼ}, yₒ_{ⱼ}), wherein Sⱼ represents the j th of the tower, Sⱼ represents a center to form two concentric circles with radius m and radius n respectively. Sⱼ₊₁ is selected to form the following equation:
$$\{ \begin{matrix}\begin{matrix}{m}^{2} \leq {( {x}_{{O}_{j + 1}} - {x}_{{O}_{j}} )}^{2} + {( {y}_{{O}_{j + 1}} - {y}_{{O}_{j}} )}^{2} \leq {n}^{2} \\ θ = arccos 〈 \vec{{S}_{j} {S}_{j + 1}} , \vec{{O}_{i} {O}_{i + 1}} 〉\end{matrix} \\ θ ∈ ( 0 , \frac{π}{2} )\end{matrix}$$
wherein a region is formed as the semi-annular domain defined as semi-annular domain Aᵣₑₐ^{j+1}, Sⱼ₊₁∈Aᵣₑₐ^{j+1};
step 6.4: configuring a grid segmentation of the semi-annular domain, wherein each of the grids is formed in an approximate square shape, wherein after the grid segmentation, the semi-annular domain is constructed to form the map with the step ring grid network; and
step 6.5: numbering the grids after the segmentation of the semi-annular domain to facilitate optimized calculation.

6. The multiple objective optimization route selection method based on a step ring grid network for a transmission line according to claim 1, characterized in that, wherein in the step 8, the Gini coefficient is expressed as:
$$Gini ( p ) = {\sum }_{k = 1}^{K} {p}_{k} ( 1 - {p}_{k} ) = 1 - {\sum }_{k = 1}^{K} {p}_{k}^{2}$$
$$Gini ( {A}_{rea}^{j + 1} , p ) = \frac{\vert {p}_{1} \vert}{\vert {A}_{rea}^{j + 1} \vert} Gini ( {p}_{1} ) + \frac{\vert {p}_{2} \vert}{\vert {A}_{rea}^{j + 1} \vert} Gini ( {p}_{2} )$$
wherein a probability p₁(S₀,S₁) is set for the constructible tower within the semi-annular domain Aᵣₑₐ^{j+1}, wherein the constructible domain is set as S₁ and the non-constructible domain is set as S₀, wherein pₖ represents an occurrence probability of k th category, wherein a complexity of the particular constructible grid is determined based on the Gini coefficient.

7. The multiple objective optimization route selection method based on a step ring grid network for a transmission line according to claim 1, characterized in that, as recited in claim 1, in the step 9,
wherein a grid parameter is configured for each grid, wherein the grid parameter comprises data of cost cᵢₙ, longitude coordinate JᵢₙNᵢ, latitude coordinate WᵢₙNᵢ, and elevation coordinate HᵢₙNᵢ, which are expressed as: D_{N}_{ᵢₙ}^{ata}={cᵢₙ, JᵢₙNᵢ, WᵢₙNᵢ, HᵢₙNᵢ}, wherein n represents the i th grid number of the semi-annular domain, wherein the latitude and longitude coordinates of the grid points are Nᵢₙ=(JᵢₙNᵢ, WᵢₙNᵢ), wherein the latitude and longitude coordinates of the constructible tower Sⱼ is expressed as Sⱼ=(JⱼSⱼ, WⱼSⱼ), which is the distance of the wire between two constructible towers:
lⱼ=(R+HᵢₙNᵢ+h)arccos(cos(WᵢₙNᵢ)cos(WⱼSⱼ)cos(JᵢₙNᵢ−JⱼSⱼ)+sin(WⱼSⱼ)sin(WᵢₙNᵢ))
wherein the assumption is that the Earth is a regular sphere, wherein the radius of Earth is determined by a distance between the sea level and the center of the Earth.

8. The multiple objective optimization route selection method based on a step ring grid network for a transmission line according to claim 1, characterized in that, in the step 10, wherein the cost objective function is expressed as:
$$C = μ {\sum }_{i = 1}^{n} {\sum }_{j = 0}^{{m}_{i}} {c}_{l} + {l}_{j} + {\sum }_{k = 1}^{N} [ {c}_{s} {f}_{k} ( F ) + {u}_{s} {G}_{k} ( F ) + {ψ}_{k} + {τ}_{k} ]$$
wherein C represents a total cost, cⱼ represents cost of the wire per unit length, μ represents a power transmission coefficient, wherein a three-phase power transmission process or DC power transmission process adopts different numbers of conductive wires depending on the power transmission type, wherein the power transmission coefficient indicates various power transmissions, wherein n and N represent the number of virtual topology map classifications and the total number of tower respectively, wherein
$${c}_{s} = {\sum }_{j = 1}^{k} {r}_{i}^{( 1 )}$$
represents a cost factor, fₖ(F) represents an estimated construction cost required based on the k th section of the site conditions, uₛ represents a transportation cost factor, Gₖ(F) represents an estimated transportation cost, Ψₖ represents a cost of tower based on the k th section of the site conditions, τₖ represents a labor cost based on the k th section of the site conditions, setting: when cᵢₙ=cₛfₖ(F)+uₛGₖ(F)+ψₖ+τₖ, an attribute is assigned to the k th section of the constructible grid.

9. The multiple objective optimization route selection method based on a step ring grid network for a transmission line according to claim 1, characterized in that, in the step 11,
wherein the starting point is set at one of the virtual topological nodes for the route planning as T={Oᵢ, i≥1∪i∈ [symbol] }, that is, the starting point refers as Oᵢ, and the end point refers as O_{N}, wherein the point of the tower is set as Sⱼ, φ(Sⱼ) is set as the total deflection angle function of the route, the vector between the towers is set as [symbol] = [symbol] , wherein by solving the minimum value of a deflection angle, the function is expressed as:
$$φ ( {S}_{j} ) = min \{ min \{ {\sum }_{i = 1}^{n} {\sum }_{j = 1}^{{m}_{i}} arccos \frac{\vert \overline{{ξ}_{j}} \cdot \overline{{ξ}_{j + 1}} \vert}{\vert \overline{{ξ}_{j}} \vert \vert \overline{{ξ}_{j + 1}} \vert} \} - arccos \frac{\vert \overline{{ξ}_{j}} \cdot \overline{{O}_{1} {O}_{N}} \vert}{\vert \overline{{ξ}_{j}} \vert \vert \overline{{O}_{1} {O}_{N}} \vert} \} ,$$
wherein Sⱼ∈Aᵣₑₐ^{j}, by setting
$${β}_{j} = arccos \frac{\vert \overline{{ξ}_{j}} \cdot \overline{{ξ}_{j + 1}} \vert}{\vert \overline{{ξ}_{j}} \vert \vert \overline{{ξ}_{j + 1}} \vert} ,$$
the deflection angle is formed by the adjacent semi-annular domain Aᵣₑₐ^{j} in the step ring grid network semi-annular domain Aᵣₑₐ^{j+1} and the selected tower point Sⱼ, selected tower point Sⱼ₊₁, and selected tower point Sⱼ₊₂ in the semi-annular domain Aᵣₑₐ^{j+2}.

10. The multiple objective optimization route selection method based on a step ring grid network for a transmission line according to claim 1, characterized in that, in the step 12, wherein the multiple objective optimization model is expressed as:
$$min F ( X ) = {w}_{1} C ( {S}_{j} ) + {w}_{2} {\sum }_{i = 1}^{n} {\sum }_{j = 0}^{{m}_{i}} {l}_{f} ( {S}_{j} ) + {w}_{3} φ ( {S}_{j} ) + {ω}_{4} {\sum }_{i = 1}^{n} {\sum }_{j = 0}^{{m}_{i}} Gini ( {A}_{rea}^{j + 1} , p )$$
wherein the constructible domain is the semi-annular domain constructed by the stepped annular grid X={Sⱼ|Sⱼ∈Aᵣₑₐ^{j+1}, j=0, 1, 2, . . . , N}, wherein a solution for the optimization problem is to set as X=(S₁, S₂, . . . , S_{N})^{T}.
